(19) United States
(12) Patent Application Publication
(10) Pub. No.: US 2026/0045707 A1
(43) Pub. Date: Feb. 12, 2026

(54) ELECTRICAL CABLE TERMINAL WITH CRIMPING WINGS

(71) Applicant: Aptive Technologies AG, Schaffhausen (CH)

(72) Inventors: Michael D. MESSURI, Canfield, OH (US); Nicole L. Liptak, Cortland, OH (US); James P. Schuster, Vienna, OH (US)

(21) Appl. No.: 18/795,660

(22) Filed: Aug. 6, 2024

(51) Int. Cl. H01R 4/18; H01R 11/28; H01R 43/16

(52) U.S. Cl. CPC H01R 4/184; H01R 11/28; H01R 43/16

(57) ABSTRACT

This disclosure describes an apparatus comprising an attachment section with a base having a first cross-sectional thickness and multiple crimping wings extending from the base with a second cross-sectional thickness larger than that of the base. The attachment section is designed to receive and secure an electrical cable in contact with the base, and its distal end is structured to be connected to a connection section of a first electrical terminal. This configuration allows for efficient and secure attachment of electrical cables to electrical terminals, ensuring reliable electrical connections in various applications.

### TECHNICAL FIELD

The subject matter disclosed herein relates to electrical cables terminals and, in particular, to electrical cable terminals having crimping wings.

### BACKGROUND

The geometry of crimp attachment of electrical terminals to electrical cables is determined by the cross-section of the electrical cable, the thickness of the material forming the electrical terminal, and thereby the crimping wings, the shape of the crimping applied to the crimping wings and the amount of compaction of the conductive core of the electrical cable. Current miniaturized high frequency electrical terminals require specific geometry of the crimp attachment in order to maximize radio frequency (RF) performance of the electrical terminal in cases where larger crimp attachment geometries are desired. The needs detailed above are unmet by current electrical terminal designs.

An example of a current miniaturized high frequency electrical terminal 1 is shown in FIG. 1A. The electrical terminal 1 has an attachment section 2 configured to attach the electrical terminal 1 to a wire electrical cable (not shown) and a connection section 3 configured to interface with a mating electrical terminal (not shown). The attachment section 2 has a base 4 in which the electrical cable may be received and a plurality of crimping wings 5 that are crimped over the electrical cable to mechanically and electrically connect the electrical terminal to the electrical cable. As can be seen in FIG. 1B, except for the thinner chamfered tips, the crimping wings 5 and the base 4 have the same cross sectional thickness.

### SUMMARY

In some aspects, the techniques described herein relate to an apparatus, including: an attachment section having a base with a first cross-sectional thickness and a plurality of crimping wings extending from the base having a second cross-sectional thickness greater than the first cross-sectional thickness of the base, the attachment section configured to receive and secure an electrical cable in contact with the base and having a distal end further configured to be joined to a connection section of a first electrical terminal.

In some aspects, the techniques described herein relate to a method of manufacturing an apparatus, including: forming an attachment section having a base with a first cross-sectional thickness and a plurality of crimping wings extending from the base having a second cross-sectional thickness, the attachment section configured to receive and secure an electrical cable in contact with the base and having a distal end further configured to be joined to a connection section of a first electrical terminal; and forming the plurality of crimping wings such that their second cross-sectional thickness is greater than the first cross-sectional thickness of the base.

In some aspects, the techniques described herein relate to an electrical terminal, including: a connection section configured to interface with a corresponding electrical terminal; and an attachment section having a base and a plurality of crimping wings extending from the base having a first cross-sectional thickness greater than a second cross-sectional thickness of the base, each crimping wing of the plurality of crimping wings having a base segment extending from the base and an end segment extending from the base segment, the end segment being folded back onto the base segment, the attachment section being integrally formed with the connection section and configured for attachment to an electrical cable.

### BRIEF DESCRIPTION OF THE DRAWINGS

FIG. 1A is an isometric view of an electrical terminal according to the prior art.

FIG. 1B is a cross-section view of an attachment portion of the electrical terminal of FIG. 1A according to the prior art.

FIG. 2A is an isometric view of an electrical terminal according to some embodiments.

FIG. 2B is a cross-section view of the attachment portion of FIG. 2A according to some embodiments.

FIG. 3A is an isometric view of an alternative electrical terminal according to some embodiments.

FIG. 3B is a cross-section view of the attachment portion of FIG. 3A according to some embodiments.

FIG. 4 is an isometric view of another alternative electrical terminal according to some embodiments.

FIG. 5 is a cross-section view of the electrical terminal FIG. 2A attached to an electrical cable according to some embodiments.

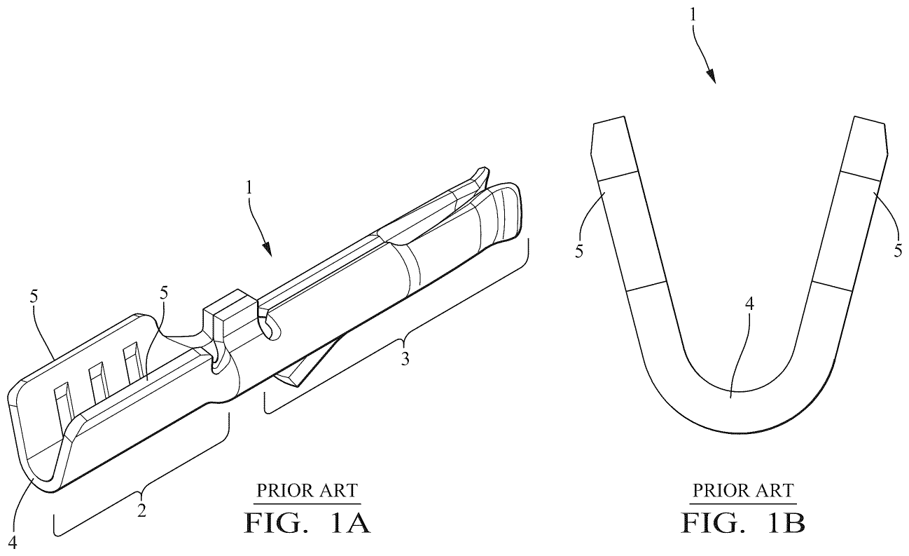

### DETAILED DESCRIPTION

The present disclosure describes an apparatus, such as an electrical terminal, which has crimping wings that are thicker than a base segment of an attachment portion of the electrical terminal is disclosed.

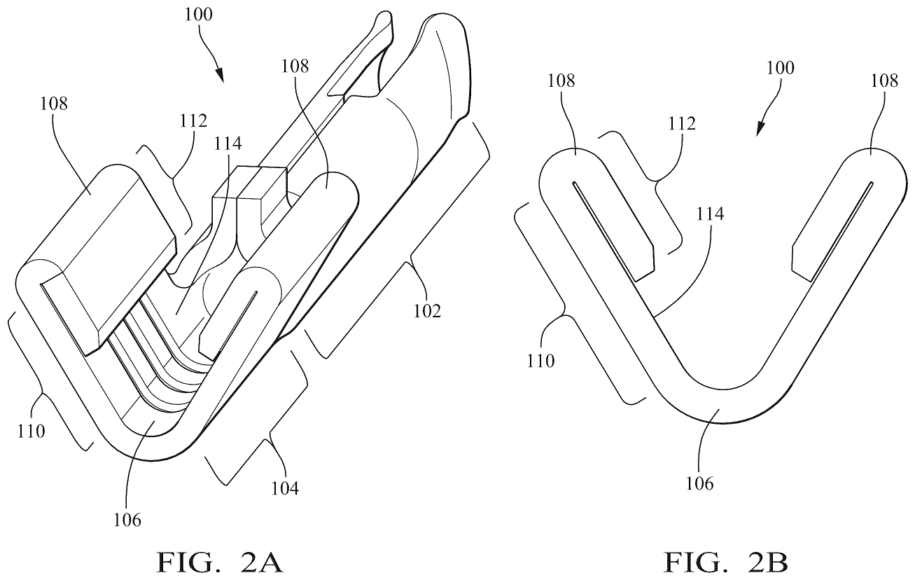

FIGS. 2A and 2B show a non-limiting example of a terminal 100 having a female connection section 102 that is configured to accept a male pin of a corresponding male terminal (not shown). The terminal 100 also includes an attachment section 104 extending longitudinally from the connection section 102 that has a base 106 and a plurality of crimping wings 108 extending from the base 106. The connection section 102 may be integrally formed with the attachment section 104.

The crimping wings 108 each have a base segment 110 extending from the base 106 and an end segment 112 extending from the base segment 110. In this example, the end segment 112 is folded back over the base segment 110 to provide crimping wings 108 that are thicker than the base 106 to provide additional material in the crimping wings 108, thereby resulting in a larger core crimp width and core crimp height while still achieving desirable core compaction.

The crimping wings 108 in the illustrated examples in FIGS. 2A and 2B are made of sheet metal and folded back onto themselves using a metal stamping process to provide thicker crimping wings 108. In the example shown in FIGS. 2A and 2B, the end segment 112 is folded over an inner surface 114 of the base segment 110.

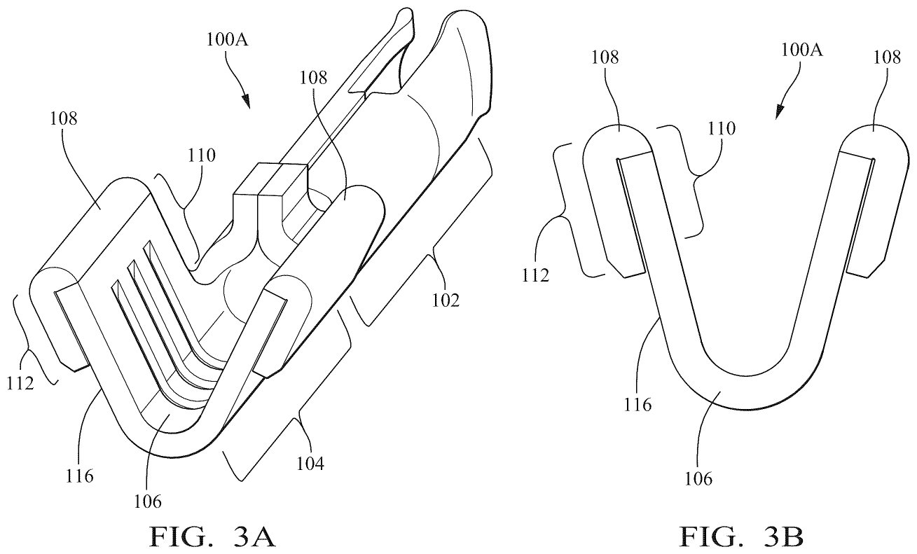

FIGS. 3A and 3B show another example of a terminal 100A which has all of the features of terminal 100 described above, however in this example, the end segment 112 is folded over an outer surface 116 of the base segment 110.

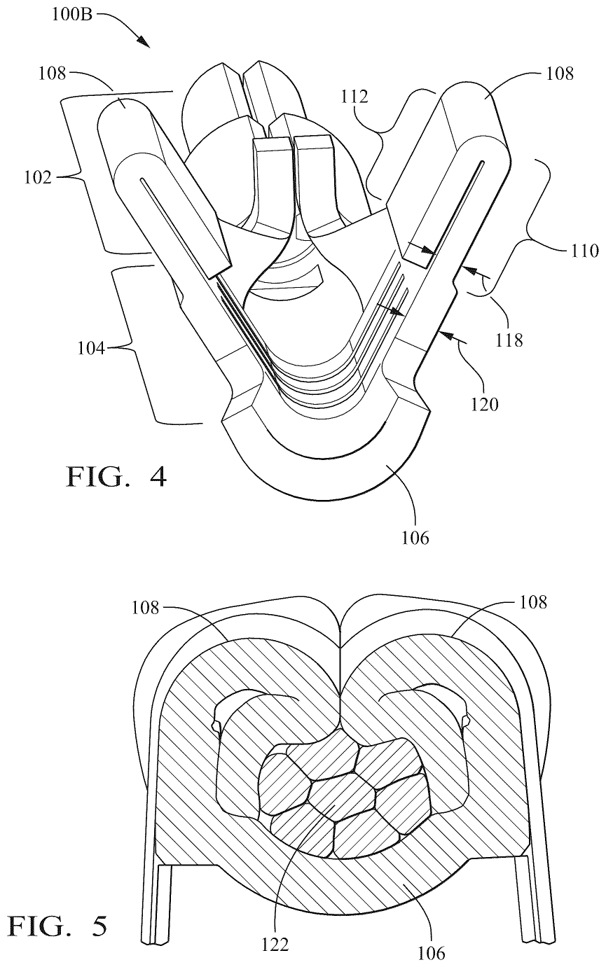

FIG. 4 shows yet another example of a terminal 100B which has all of the features of terminal 100 described above, however in this example, the thickness 118 of the crimping wings 108 is reduced, e.g., using a stamping or milling process relative to the thickness 120 of the base 106, prior to folding the end segment 112 over the base segment 110.

As shown in FIG. 5, the crimping wings 108 surround a diameter of a wire cable 122 received in the attachment section when they are crimped over the wire cable 122.

These thicker crimping wings 108 allow for larger core crimp widths and core crimp heights to be achieved, thereby reducing impedance mismatch of the terminal 100, 100A, 100B in the critical zone between the inner terminal crimp and outer terminal body. Other embodiments of the terminal may be envisioned in which the thicker crimping wings 108 of the attachment section 104 are formed by using a metal stamping process to thin the sheet metal material forming the base 106 relative to the crimping wings 108. Crimping wings 108 that are thicker than the base 106 may also be formed using other processes, such as milling, casting, cladding, or additive manufacturing (e.g., 3D printing) processes.

The crimping wings 108 provide an RF tuning feature for the terminal 100, 100A, 100B and allows additional core crimp geometries to be utilized for optimal signal integrity, while maintaining electrical performance.

Further, the crimping wings 108 provide additional thickness of material around the wire cable 122, enhancing mechanical crimp strength performance. The thickness of crimping wings 108 may be adjustable during the stamping operation to optimize the ratio of external core crimp height and core crimp width with internal core crimp compaction targets.

Additionally, the crimping wings 108 allow for various cable sizes to be crimped using the same crimping tooling and common crimping tool dimensions.

While the illustrated examples of the attachment portion are directed for use with an electrical terminal for terminating electrical cables, the attachment portion may be used to terminate ropes such as braided wire, polymer, and natural fiber ropes.

### Discussion of Possible Embodiments

The following are non-exclusive descriptions of possible embodiments of the present invention.

In some aspects, the techniques described herein relate to an apparatus, including: an attachment section having a base with a first cross-sectional thickness and a plurality of crimping wings extending from the base having a second cross-sectional thickness greater than the first cross-sectional thickness of the base, the attachment section configured to receive and secure an electrical cable in contact with the base and having a distal end further configured to be joined to a connection section of a first electrical terminal.

The apparatus of the preceding paragraph can optionally include, additionally and/or alternatively any, one or more of the following features/steps, configurations and/or additional components.

In some aspects, the techniques described herein relate to an apparatus, each crimping wing of the plurality of crimping wings having a base segment extending from the base and an end segment extending from the base segment, the end segment being folded back onto the base segment to provide the second cross-sectional thickness.

In some aspects, the techniques described herein relate to an apparatus, the end segment being folded over an inner surface of the base segment.

In some aspects, the techniques described herein relate to an apparatus, the end segment being folded over an outer surface of the base segment.

In some aspects, the techniques described herein relate to an apparatus, the end segment having a third cross-sectional thickness which is less than the second cross-sectional thickness of the base.

In some aspects, the techniques described herein relate to an apparatus, further including the connection section of the first electrical terminal.

In some aspects, the techniques described herein relate to an apparatus, the connection section being configured to interface with a second electrical terminal.

In some aspects, the techniques described herein relate to an apparatus, the connection section being integrally formed with the attachment section.

In some aspects, the techniques described herein relate to an apparatus, further including a wire cable, the plurality of crimping wings being crimped to surround a diameter of the wire cable.

In some aspects, the techniques described herein relate to a method of manufacturing an apparatus, including: forming an attachment section having a base with a first cross-sectional thickness and a plurality of crimping wings extending from the base having a second cross-sectional thickness, the attachment section configured to receive and secure an electrical cable in contact with the base and having a distal end further configured to be joined to a connection section of a first electrical terminal; and forming the plurality of crimping wings such that their second cross-sectional thickness is greater than the first cross-sectional thickness of the base.

The method of the preceding paragraph can optionally include, additionally and/or alternatively any, one or more of the following features/steps, configurations and/or additional components.

In some aspects, the techniques described herein relate to a method, wherein the connection section is configured to interface with a corresponding electrical terminal.

In some aspects, the techniques described herein relate to a method, further including integrally forming the connection section with the attachment section.

In some aspects, the techniques described herein relate to a method, wherein each crimping wing of the plurality of crimping wings having a base segment extending from the base and an end segment extending from the base segment and wherein the method further includes folding the end segment of each crimping wing back onto the base segment of each crimping wing to provide the second cross-sectional thickness.

In some aspects, the techniques described herein relate to a method, wherein the end segment is folded over an inner surface of the base segment.

In some aspects, the techniques described herein relate to a method, wherein the end segment is folded over an outer surface of the base segment.

In some aspects, the techniques described herein relate to a method, further including reducing a third cross-sectional thickness of the end segment to be less than the second cross-sectional thickness of the base.

In some aspects, the techniques described herein relate to a method, further including disposing a wire cable in the attachment section; and crimping the plurality of crimping wings to a wire cable.

In some aspects, the techniques described herein relate to a method, wherein relative lengths of base segment and the end segment are dependent upon a cross-sectional area of the wire cable.

In some aspects, the techniques described herein relate to a method, wherein the plurality of crimping wings are crimped to surround a diameter of the wire cable.

In some aspects, the techniques described herein relate to an electrical terminal, including: a connection section configured to interface with a corresponding electrical terminal; and an attachment section having a base and a plurality of crimping wings extending from the base having a first cross-sectional thickness greater than a second cross-sectional thickness of the base, each crimping wing of the plurality of crimping wings having a base segment extending from the base and an end segment extending from the base segment, the end segment being folded back onto the base segment, the attachment section being integrally formed with the connection section and configured for attachment to an electrical cable.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, upper, lower, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/of” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. An apparatus, comprising:
an attachment section having a base with a first cross-sectional thickness and a plurality of crimping wings extending from the base and having a second cross-sectional thickness greater than the first cross-sectional thickness of the base, the attachment section configured to receive and secure an electrical cable in contact with the base and having a distal end further configured to be joined to a connection section of a first electrical terminal.

2. The apparatus in accordance with claim 1, each crimping wing of the plurality of crimping wings having a base segment extending from the base and an end segment extending from the base segment, the end segment being folded back onto the base segment to provide the second cross-sectional thickness.

3. The apparatus in accordance with claim 2, the end segment being folded over an inner surface of the base segment.

4. The apparatus in accordance with claim 2, the end segment being folded over an outer surface of the base segment.

5. The apparatus in accordance with claim 2, the end segment having a third cross-sectional thickness which is less than the second cross-sectional thickness of the base.

6. The apparatus in accordance with claim 1, further comprising the connection section of the first electrical terminal.

7. The apparatus in accordance with claim 6, the connection section being configured to interface with a second electrical terminal.

8. The apparatus in accordance with claim 6, the connection section being integrally formed with the attachment section.

9. The apparatus in accordance with claim 8, further comprising a wire cable, the plurality of crimping wings being crimped to surround a diameter of the wire cable.

10. A method of manufacturing an apparatus, comprising:
forming an attachment section having a base with a first cross-sectional thickness and a plurality of crimping wings extending from the base having a second cross-sectional thickness, the attachment section configured to receive and secure an electrical cable in contact with the base and having a distal end further configured to be joined to a connection section of a first electrical terminal; and
forming the plurality of crimping wings such that their second cross-sectional thickness is greater than the first cross-sectional thickness of the base.

11. The method in accordance with claim 10, wherein the connection section is configured to interface with a corresponding electrical terminal.

12. The method in accordance with claim 10, further comprising integrally forming the connection section with the attachment section.

13. The method in accordance with claim 10, wherein each crimping wing of the plurality of crimping wings having a base segment extending from the base and an end segment extending from the base segment and wherein the method further comprises folding the end segment of each crimping wing back onto the base segment of each crimping wing to provide the second cross-sectional thickness.

14. The method in accordance with claim 13, wherein the end segment is folded over an inner surface of the base segment.

15. The method in accordance with claim 13, wherein the end segment is folded over an outer surface of the base segment.

16. The method in accordance with claim 13, further comprising reducing a third cross-sectional thickness of the end segment to be less than the second cross-sectional thickness of the base.

17. The method in accordance with claim 13, further comprising:
disposing a wire cable in the attachment section; and
crimping the plurality of crimping wings to a wire cable.

18. The method in accordance with claim 17, wherein relative lengths of base segment and the end segment are dependent upon a cross-sectional area of the wire cable.

19. The method in accordance with claim 17, wherein the plurality of crimping wings are crimped to surround a diameter of the wire cable.

20. An electrical terminal, comprising:
a connection section configured to interface with a corresponding electrical terminal; and
an attachment section having a base and a plurality of crimping wings extending from the base having a first cross-sectional thickness greater than a second cross-sectional thickness of the base, each crimping wing of the plurality of crimping wings having a base segment extending from the base and an end segment extending from the base segment, the end segment being folded back onto the base segment, the attachment section being integrally formed with the connection section and configured for attachment to an electrical cable.
